(19) United States
(12) Patent Application Publication
(10) Pub. No.: US 2006/0230897 A1
(43) Pub. Date: Oct. 19, 2006

(54) Sawdust containment apparatus system and method

(76) Inventor: Willis L. Hardy, Spanish Fork, UT (US)

Correspondence Address: UTAH VALLEY PATENT SERVICES, LLC, 846 S. 1350 E., PROVO, UT, 84606, US

(21) Appl. No.: 11/104,761

(22) Filed: Apr. 13, 2005

(51) Int. Cl. B23D 45/06

(52) U.S. Cl. 83/100; 83/490

(57) ABSTRACT

An apparatus, system, and method are disclosed for catching sawdust from a circular miter saw. The apparatus, in one embodiment, is configured to receive sawdust emitted from an operating circular miter saw and to retain the sawdust within a sawdust receiver. The apparatus may include a sawdust receiver to accumulate sawdust and one or more flexible retention members to substantially segregate portions of a circular miter saw disposed within the sawdust receiver from portions of a circular miter saw outside the sawdust receiver. The flexible retention member may be coupled to the sawdust receiver to prevent sawdust from escaping from the sawdust receiver.

### BACKGROUND OF THE INVENTION

1. Field of the Invention

This invention relates to sawing device accessories and more particularly relates to containment devices for catching sawdust.

2. Description of the Related Art

Saws are commonly used for multiple purposes at both industrial and domestic applications. A common circular saw is the miter saw, or chop saw, which is typically used to make quick, accurate crosscuts in a workpiece. FIG. 1A illustrates one embodiment of a circular miter saw 100. Circular miter saws such as the circular miter saw 100 generally include a circular blade 102, a blade guard 104, a fence 106 for referencing a miter angle, a miter index 108 for manipulating the angle of the blade 102, and a handle 110 for controlling the blade 102. Other common features may include a compound feature for changing the angle of the blade 102 relative to the horizontal plane, a slide for extending the cutting plane, a laser guide for determining the cut and/or kerf, and a safety clamp for locking a workpiece into position.

Sawdust, the common byproduct of sawing, typically litters the area surrounding a sawing device. Throughout the years, many people have attempted to contain the residual sawdust to maintain a clean work area. However, because miter saws 100 generally require a great deal of movement to adjust the blade angle and the blade 102, sawdust containment devices have typically hindered the cutting process or placed an undue burden on the operator.

For example, one common method to capture sawdust is to attach a breathable bag at the end of an exhaust tube that is integral to the blade guard 104. Typically, however, such bags must be relatively small in order to not interfere with sawing operations. As a result, to be effective such breathable bags must be emptied frequently, thus diverting the operator from his or her intended task.

From the foregoing discussion, it should be apparent that a need exists for an apparatus, system, and method that effectively contain residual sawdust without hindering the functional components of a circular miter saw 100 or burdening the operator. Beneficially, such an apparatus, system, and method would provide a sawdust receiving area sufficiently sized to catch a majority of the sawdust, enable easy removal and cleanup of the sawdust, and significantly reduce or eliminate the need to divert the operator from his or her intended task. Consequently, the operator would be able to accurately cut a workpiece without having to worry about sawdust littering the work area.

### SUMMARY OF THE INVENTION

The present invention has been developed in response to the present state of the art, and in particular, in response to the problems and needs in the art that have not yet been fully solved by currently available sawdust containment devices. Accordingly, the present invention has been developed to provide an apparatus, system, and method for catching sawdust from a circular miter saw that overcome many or all of the above-discussed shortcomings in the art.

The apparatus, in one embodiment, is configured to receive sawdust emitted from an operating circular miter saw and to retain the sawdust within a sawdust receiver. The apparatus may include a sawdust receiver that accumulates sawdust and one or more flexible retention members that substantially surround a circular miter saw and retain sawdust within the sawdust receiver. The sawdust receiver may include an opening sufficient to encompass portions of a circular miter saw, and one or more flexible retention members coupled to the opening. The flexible retention members may substantially segregate portions of a circular miter saw disposed within the sawdust receiver from portions of the circular miter saw outside the receiver in order to retain sawdust within the sawdust receiver.

In one embodiment, the flexible retention member is a curtain that drapes around a circular miter saw. In another embodiment, one or more brushes disposed around the perimeter of the opening of the sawdust receiver function as the flexible retention members. In yet another embodiment, the flexible retention member comprises an elastic barrier. Thus, the flexible retention member(s) enable movement of the circular miter saw while preventing sawdust from escaping from the sawdust receiver.

In one embodiment, the apparatus also includes a venting orifice that facilitates removal of the sawdust. In certain embodiments, the venting orifice may be coupled to a vacuum system. Alternatively, the venting orifice may be gravity fed. In one embodiment, a venting channel directs the sawdust to the venting orifice, or to another container or the like.

A system of the present invention is also presented for catching sawdust from a circular miter saw. The system, in one embodiment, includes a sawdust receiver, at least one flexible retention member coupled to the sawdust receiver, and a stand to bear a circular miter saw. The stand may facilitate catching and/or retaining sawdust in the sawdust receiver and enable easy removal of the sawdust from the sawdust receiver. The system may further include a circular miter saw and a vacuum system in certain embodiments. In one embodiment, the aforementioned venting channel is integral to the stand.

A method of the present invention is also presented for containing sawdust from a circular miter saw. The method in the disclosed embodiments substantially includes the steps necessary to carry out the functions presented above with respect to the operation of the described apparatus and system. In one embodiment, the method includes providing a sawdust receiver with an opening for receiving sawdust and at least one flexible member, inserting a circular miter saw into the opening and operating the circular miter saw, and catching sawdust from the circular miter saw in the sawdust receiver. The method also may include removing sawdust from the sawdust receiver.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The apparatus, method, and system of the present invention contain residual sawdust emitted from a circular miter saw without hindering the functional components of a circular miter saw or burdening the operator. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a front perspective view illustrating a circular miter saw;

FIG. 1B is a front perspective view illustrating one embodiment of a sawdust receiver of the present invention in conjunction with a circular miter saw;

FIGS. 2A-2B are perspective views illustrating one embodiment of a circular miter saw in a functional position and an extended position;

FIG. 3 is a front perspective view illustrating an alternative embodiment of a sawdust receiver of the present invention in conjunction with a circular miter saw;

FIG. 4 is a side view illustrating one embodiment of a sawdust containment system of the present invention; and

FIG. 5 is a schematic flow chart diagram illustrating one embodiment of a sawdust containment method in accordance with the present invention.

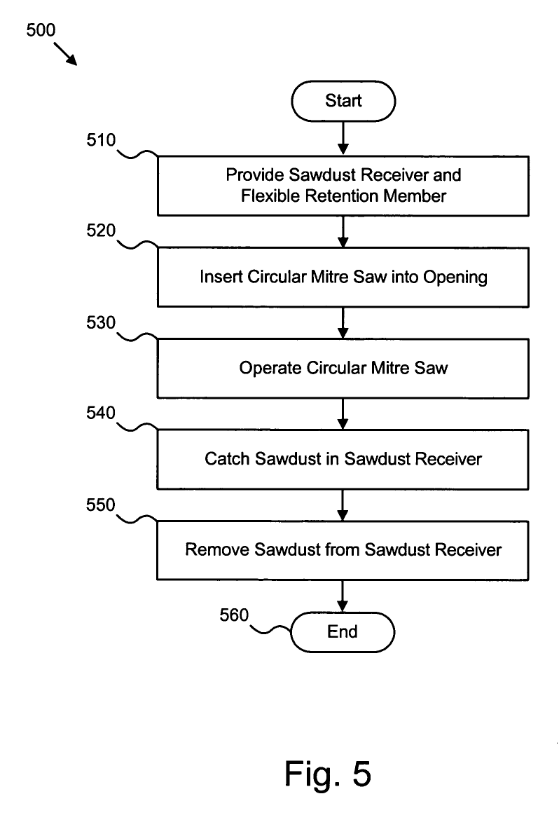

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to give a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

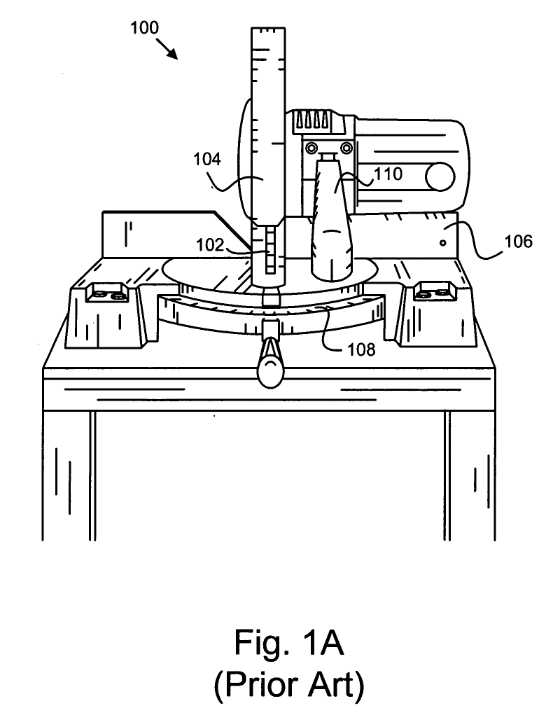

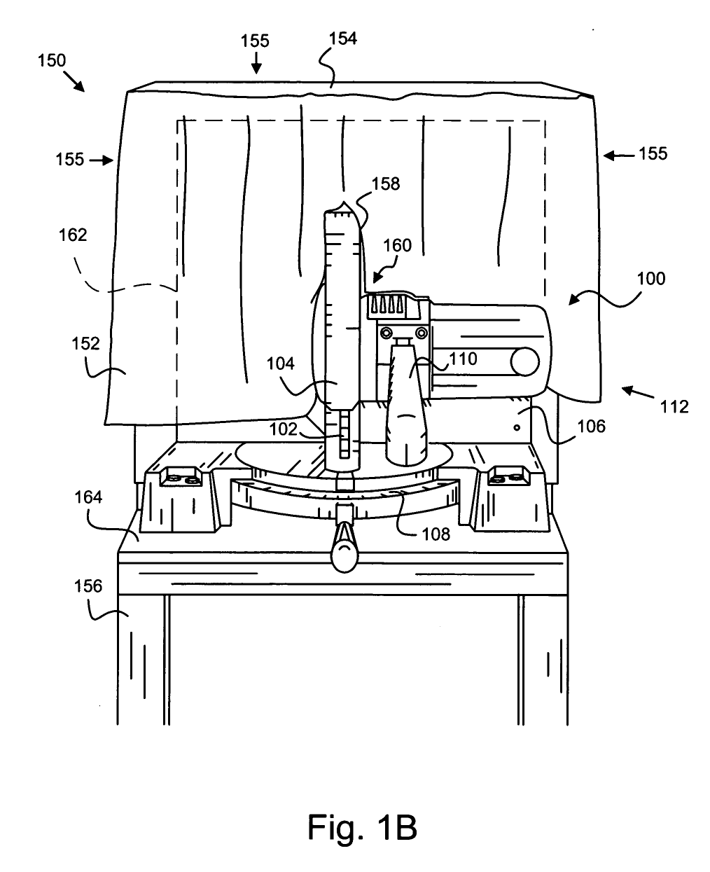

FIG. 1B depicts one embodiment of a sawdust containment device 150 of the present invention. The sawdust containment device 150 as illustrated includes a flexible retention member 152, a sawdust receiver 154, and a stand 156. A circular miter saw 100 is further depicted in conjunction with the sawdust containment device 150. In a preferred embodiment, the sawdust containment device 150 catches residual sawdust emitted from the circular miter saw 100 during operation, thereby retaining the sawdust and preventing messes. The operator, consequently, may focus on the workpiece and making accurate cuts without worrying about the residual sawdust or the cleanup process. The sawdust may be retained in a container, vacuum system, or the like, away from the work surface and surrounding area.

In the depicted embodiment, the flexible retention member 152 is a fabric curtain covering an opening 162 (represented by dotted lines) in the sawdust receiver 154; though other materials and configurations are conceivable. Contemplated materials for the depicted flexible retention member 152 include, but are not limited to, plastic, flexible foam, synthetic fibers, elastic, etc. The curtain 152 may drape around a circular miter saw 100 as illustrated.

The curtain 152, or flexible retention member 152, retains sawdust within the sawdust receiver 154. The flexible retention member 152 substantially segregates portions of the circular miter saw 100, isolating a back portion (not shown) within the sawdust receiver 154 and preventing release of sawdust into the open. In addition, a slit 158 or the like may be formed in the curtain 152 to accommodate various types of circular miter saws such as the depicted circular miter saw 100. In select embodiments, the flexible retention member 152 further includes one or more comers 160 or the like formed to create a flexible fit around the components of the miter saw 100.

Consequently, sawdust emitted from the miter saw 100 may be retained within the sawdust containment device 150 without hindering the functionality of the miter saw 100. The visible front portion 112 of the miter saw 100 outside the sawdust receiver 154 enables the user to operate the miter saw 100 as normal. The flexible retention member 152 preferably enables the miter angle/index 108 to be adjusted and allows the blade 102 to be easily manipulated. In one embodiment, the flexible retention member 152 is made of denim cloth, which readily retains sawdust, enables movement of the miter saw 100, and may be easily removed and cleaned. In alternative embodiments, the flexible retention member 152 may be a brush, an elastic barrier, or any other material or device that enables movement of the miter saw 100 and retains the sawdust within the sawdust receiver 154. In addition, the flexible retention member 152 may comprise a combination of materials or flexible retention members 152 to fit a variety of different circular miter saws 100.

The sawdust receiver 154 preferably receives the sawdust emitted from the circular miter saw 100. The sawdust receiver 154, in certain embodiments, comprises a box with sides 155 and an opening 162. The opening 162 may be dimensioned to receive a circular miter saw 100 as depicted, with a portion of the circular miter saw 100 encompassed within the sawdust receiver 154. As a result, sawdust emitted from the circular miter saw 100 may be received into the sawdust receiver 154.

In one embodiment, the sawdust receiver 154 may comprise a flexible material with a support structure to maintain the opening 162 in a receiving position. The sawdust receiver 154 may have a variety of shapes and configurations. In certain embodiments, the sawdust receiver 154 may be substantially enclosed. In addition, the sawdust receiver 154 may contain one or more venting orifices (not shown) to enable removal of collected sawdust. In the depicted embodiment, the sawdust receiver 154 is configured to be supported by a stand 156.

The stand 156, in certain embodiments, supports both the circular miter saw 100 and the sawdust containment device 150. In one embodiment, the stand 156 includes a horizontal surface 164 that is integral to the sawdust receiver 154 and supports a circular miter saw 100. Alternatively, a stand 156 to support the sawdust containment device 150 may be used in conjunction with a standard table to support the circular miter saw 100. The stand 156 may further include one or more venting orifices (not shown) to facilitate removal of collected sawdust. In an alternative embodiment, the sawdust containment device 150 may be self-contained and may be configured to rest on any suitable surface.

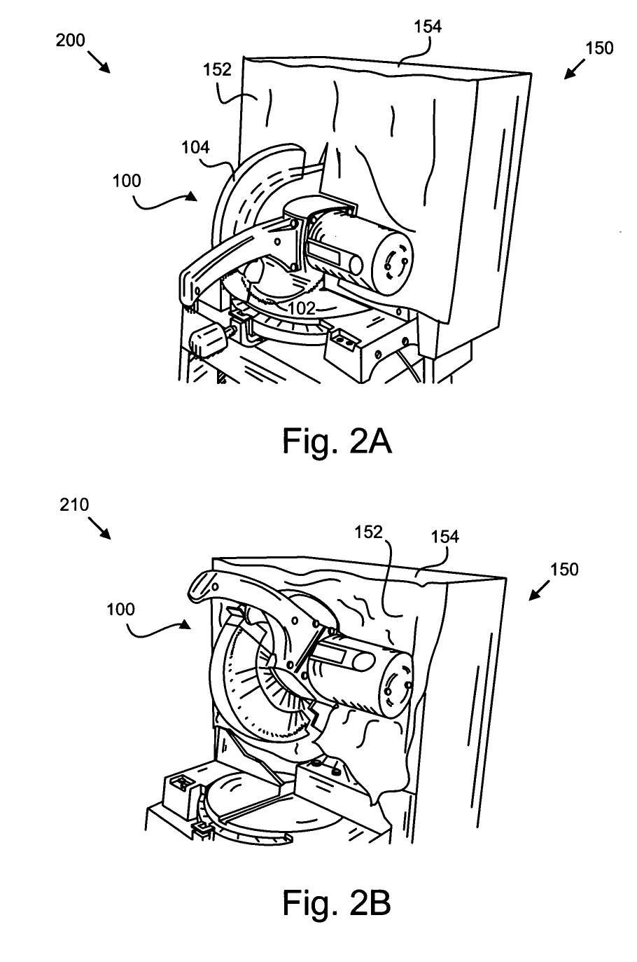

FIGS. 2A-2B illustrate one embodiment of a circular miter saw 100 used in conjunction with a sawdust containment device 150 (See FIG. 1). FIG. 2A illustrates a circular miter saw 100 in a functional position 200, which enables the blade 102 to engage a workpiece. In a functional position 200, the flexible retention member 152 substantially segregates the circular miter saw 100, such that a portion of the circular miter saw 100 is disposed within the sawdust receiver 154 and a portion remains outside of the sawdust receiver 154. Consequently, sawdust particles emitted during operation are retained within the sawdust containment device 150. The guards 104 typically built around the blades 102 protect the flexible retention member 152 from the moving blade 102 of the circular miter saw 100.

FIG. 2B illustrates the circular miter saw 100 in an extended position 210. In an extended position 210, the flexible retention member 152 enables adjustment and movement of the miter saw 100. In the depicted embodiment, the one or more curtains 152 enable the miter saw 100 to easily disengage a workpiece and extend back into the curtain 152. The cutting and measuring components of the miter saw 100 remain unaffected by the flexible retention member 152 or the sawdust receiver 154. As a result, the operator may easily manipulate the miter saw 100 while benefiting from the sawdust containment device 150. Other forms of a flexible retention member 152 may provide similar benefits.

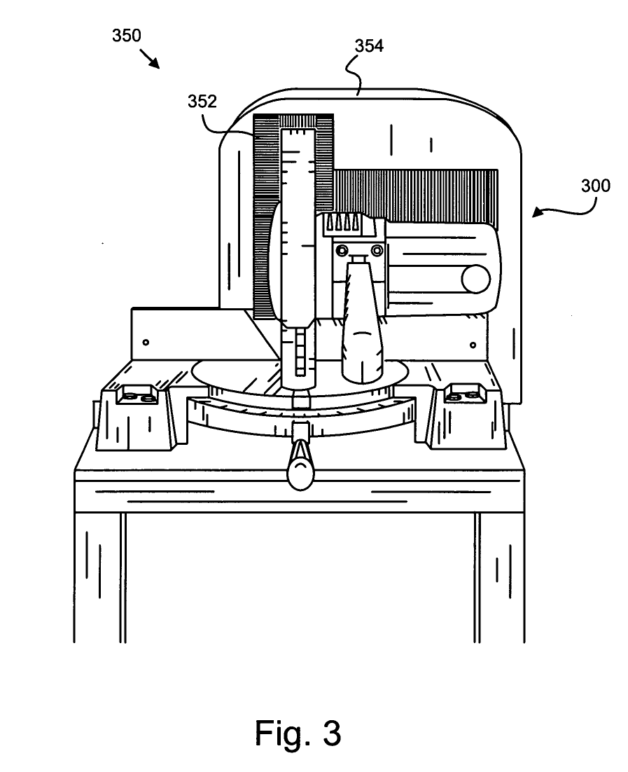

FIG. 3 illustrates an alternative embodiment of a sawdust receiver 350 of the present invention. As illustrated, the sawdust receiver 350 includes a flexible retention member 352 that substantially encloses a portion of a circular miter saw 300 within a sawdust receiver 354. The flexible retention member 352 may comprise strands of synthetic fibers, similar to a brush and be shaped to fit around a circular miter saw 300. Consequently, the flexible retention member 352 prevents sawdust from escaping from the sawdust receiver 350 without hindering the functionality of the miter saw 300. The circular miter saw 300 may be adjusted and raised to an extended position 210 (FIG. 2B) without being blocked by the flexible retention member 352. In certain embodiments, the flexible retention member 352 maybe hinged to the sawdust receiver 354. Those of skill in the art will recognize that other materials and configurations may be used to retain sawdust within the sawdust receiver, and therefore, the present invention is not limited to the disclosed embodiments.

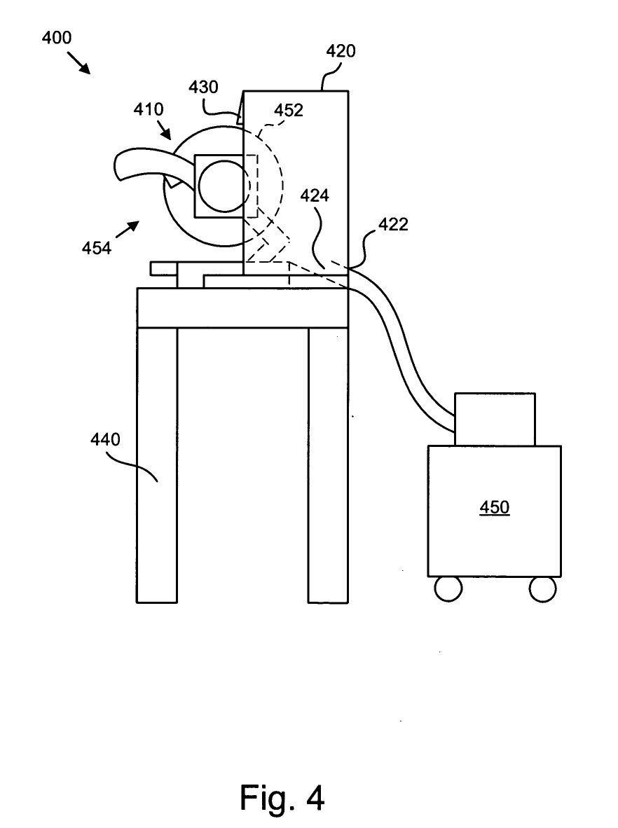

FIG. 4 illustrates a side view of one embodiment of a sawdust containment system 400 of the present invention. The sawdust containment system 400 as illustrated includes a circular miter saw 410, a sawdust receiver 420, a flexible retention member 430, a stand 440, and a vacuum system 450. The flexible retention member 430 substantially segregates an enclosed back portion 452 from a visible front portion 454.

The sawdust containment system 400 may further enable removal of the sawdust from the sawdust receiver 420. In one embodiment, the sawdust receiver 420 and/or the stand 440 comprise a venting orifice 422 and a venting channel 424. The sawdust emitted from the operating miter saw 410 may be retained within the sawdust receiver 420 and directed from the venting channel 424 to the venting orifice 422. In certain embodiments, the venting channel 424 is gravity fed. Alternatively, a vacuum system 450 may further assist in the removal and containment of residual sawdust. In certain embodiments, a venting orifice 422 formed in the bottom of the sawdust receiver 420 enables collected sawdust to drop directly into a container.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Additionally, the order in which a particular method occurs may or may not strictly adhere to the order of the corresponding steps shown.

FIG. 500 illustrates one embodiment of a sawdust containment method 500 of the present invention. The sawdust containment method 500 as depicted includes the steps of providing 510 a sawdust receiver and one or more flexible retention members, inserting 520 a circular miter saw, operating 530 the circular miter saw, catching 540 the sawdust, and removing 550 the sawdust from the sawdust receiver. The flexible retention member(s), such as the flexible retention member 152 illustrated in FIGS. 1-2, retains the sawdust emitted during operation within the sawdust receiver 154 without hindering the miter saw 100.

The miter saw 100 may be inserted 520 into the opening 162 of a sawdust receiver 154 such that the flexible retention member 152 coupled to the sawdust receiver 154 substantially encloses portions of the circular miter saw 100 disposed within the sawdust receiver 154 and enables movement of the circular miter saw 100. In one embodiment, the user adjusts and operates 530 the circular miter saw 100 with the flexible retention member 152 positioned to catch 540 and/or retain sawdust in the sawdust receiver 154. The retained sawdust may subsequently be removed 550 from the sawdust receiver through a venting orifice or the like. The venting orifice may be coupled to a vacuum system in certain embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for catching sawdust from a circular miter saw, the apparatus: comprising:
a sawdust receiver configured to accumulate sawdust emitted from an operating circular miter saw, the sawdust receiver comprising an opening sufficient to encompass portions of a circular miter saw while allowing free operation of a circular miter saw; and
at least one flexible retention member coupled to the sawdust receiver, the at least one flexible retention member configured to substantially segregate portions of a circular miter saw disposed within the sawdust receiver from portions of a circular miter saw outside the sawdust receiver and thereby retain sawdust within the sawdust receiver.

2. The apparatus of claim 1, wherein the at least one flexible retention member comprises a curtain.

3. The apparatus of claim 1, wherein the at least one flexible retention member comprises a brush.

4. The apparatus of claim 1, wherein the at least one flexible retention member comprises an elastic barrier.

5. The apparatus of claim 1, wherein the sawdust receiver further comprises a venting orifice configured to couple to a vacuum system.

6. The apparatus of claim 5, wherein the sawdust receiver further comprises a venting channel configured to direct sawdust to the venting orifice.

7. The apparatus of claim 6, wherein the venting channel is gravity fed.

8. The apparatus of claim 1, further comprising a circular miter saw.

9. The apparatus of claim 1, further comprising a stand configured to bear a circular miter saw.

10. A system for catching sawdust from a circular miter saw, the system comprising:
a sawdust receiver configured to accumulate sawdust emitted from an operating circular miter saw, the sawdust receiver comprising an opening sufficient to encompass portions of a circular miter saw while allowing free operation of a circular miter saw;
at least one flexible retention member coupled to the sawdust receiver, the at least one flexible retention member configured to substantially segregate portions of a circular miter saw disposed within the sawdust receiver from portions of a circular miter saw outside the sawdust receiver and thereby retain sawdust within the sawdust receiver; and
a stand configured to bear a circular miter saw.

11. The system of claim 10, further comprising a circular miter saw.

12. The system of claim 10, wherein the sawdust receiver further comprises a venting orifice configured to couple to a vacuum system.

13. The system of claim 12, further comprising a vacuum system.

14. The system of claim 12, wherein the sawdust receiver further comprises a venting channel configured to direct sawdust to the venting orifice.

15. The system of claim 12, wherein the at least one flexible retention member comprises a curtain.

16. A method for catching sawdust from a circular miter saw, the method comprising:
providing a sawdust receiver configured to accumulate sawdust emitted from an operating circular miter saw, the sawdust receiver comprising an opening sufficient to encompass portions of a circular miter saw while allowing free operation of a circular miter saw, and at least one flexible retention member coupled to the sawdust receiver, the at least one flexible retention member configured to substantially segregate portions of a circular miter saw disposed within the sawdust receiver from portions of a circular miter saw outside the sawdust receiver and thereby retain sawdust within the sawdust receiver;
inserting a circular miter saw into the opening of the sawdust receiver and operating the circular miter saw; and
catching sawdust from the circular miter saw in the sawdust receiver.

17. The method of claim 16, further comprising removing sawdust from the sawdust receiver.

18. The method of claim 16, wherein the sawdust is removed through a venting orifice configured to couple to a vacuum system.

19. The method of claim 16, wherein the sawdust is channeled by way of a venting channel configured to direct sawdust to the venting orifice.

20. The method of claim 16, wherein the sawdust is gravity fed through a venting orifice in the sawdust receiver.
